(19) United States
(12) Patent Application Publication
(10) Pub. No.: US 2021/0255600 A1
(43) Pub. Date: Aug. 19, 2021

(54) Method For Producing A Dental Restoration

(71) Applicant: Ivoclar Vivadent AG, Schaan (LI)

(72) Inventor: Alexander Faust, Berneck (CH)

(21) Appl. No.: 17/178,296

(22) Filed: Feb. 18, 2021

(30) Foreign Application Priority Data
Feb. 19, 2020 (EP) 20158257.4

(51) Int. Cl. G05B 19/4099; A61C 13/00; G06N 3/08

(52) U.S. Cl. CPC G05B 19/4099; A61C 13/0022; A61C 13/0004; G05B 2219/32335; G05B 2219/45145; G05B 2219/45167; G05B 2219/35134; G06N 3/08

(57) ABSTRACT

The present invention relates to a method for producing a dental restoration, comprising the steps of generating (S101) a three-dimensional dataset for describing the spatial shape of the dental restoration in a blank; adding (S102) the spatial shape of the dental restoration to a dataset of the blank; and integrating (S103) spatial data for holding pins for fixing the dental restoration into the three-dimensional dataset of the blank by a machine learning algorithm (103).

### CROSS-REFERENCE TO RELATED APPLICATIONS

This application claims priority to European patent application No. 20158257.4 filed on Feb. 19, 2020, the disclosure of which is incorporated herein by reference in its entirety.

### FIELD OF THE INVENTION

The present invention relates to a method for producing a dental restoration, a computer program for producing a dental restoration and a milling device for producing a dental restoration.

### BACKGROUND

For the production of different dental restorations, the designed restorations are placed in material blanks, which can have different shapes, by means of CAM software.

Holding pins for fixing the dental restoration within the material blank are produced on the basis of pre-set standard parameters. For example, the distance to the preparation boundary is defined hereby. The number of holding pins is determined by the volume of the dental restoration. However, satisfactory positioning, in terms of dental technology, of the holding pins cannot be determined thereby. Therefore, manual adaptation of the automatically proposed holding pins is often required.

US 20070048689, 20090319068, 20200000562, 20200179082, U.S. Pat. Nos. 10,838,398, 10,722,974, 9,939,806, 8,655,628, 8,483,857, 8,214,178, and 8,209,044, are directed to methods and materials for making dental restorations and are hereby incorporated by reference in their entirety. U.S. Pat. Nos. 10,915,934, 10,871,764, and 10,882,303, are directed to methods/machines using computers in carrying out various processes and are hereby incorporated by reference in their entirety.

### SUMMARY

It is the technical object of the present invention to facilitate the production of a dental restoration even according to dental specifications with holding pins.

This object is achieved by the subject-matter according to the independent claims. Advantageous embodiments are subject to the dependent claims, the description and the figures.

According to a first aspect, this technical object is achieved by a method for producing a dental restoration, comprising the steps of providing a disc or blank of material; generating a three-dimensional dataset for describing the spatial shape of the dental restoration in a blank; adding the spatial shape of the dental restoration to a dataset of the blank; and integrating spatial data for holding pins for fixing the dental restoration into the three-dimensional dataset of the blank by a machine learning algorithm. The technical advantages of a high level of individual automation, a time saving and increased process reliability are achieved by the method of the basis of the machine learning algorithm. The proposed holding pins are constantly adapted based on user requirements and different dental cases and indications (crown, bridge, splint, dentures) or materials.

The dataset of the blank may include nesting or positioning of a number and/or variety of dental pieces in order to make use of the entire blank for efficiency and reduction of waste of material of the blank. The three-dimensional dataset of the dental restoration to be added to the existing blank dataset, is added to the blank in a section that is available or free in the blank. In addition to the three-dimensional dataset describing the spatial shape of the dental restoration in a blank, the spatial data for holding pins for fixing the dental restoration into the three-dimensional dataset of the blank is integrated into the dataset by a machine learning algorithm.

In a technically advantageous embodiment of the method, the machine learning algorithm comprises a trained neural network. In this way for example the technical advantage is achieved that holding pins can be determined quickly and efficiently.

In a further technically advantageous embodiment of the method, the machine learning algorithm has been trained by training data of an individual user or a group of users. In this way for example the technical advantage is achieved that the machine learning algorithm is improved by the knowledge of one or more users or experts.

In a further technically advantageous embodiment of the method, the machine learning algorithm is trained during operation by further training data or individual actual case examples. In this way for example the technical advantage is achieved that a continuous training option is achieved, and the results of the machine learning algorithm are constantly improved. In particular, it may be the case that the proposal from the machine learning algorithm is being adapted once again by a user. In this case, the learning curve is relocated in an adapted machine learning algorithm.

In a further technically advantageous embodiment of the method, the further training data or individual actual case examples are each stored in the form of three-dimensional datasets in a database. The database can be a local, network-based or cloud-based database. In this way for example the technical advantage is achieved that the arrangement and shape of the holding pins is continuously improved.

In a further technically advantageous embodiment of the method, the machine learning algorithm sets the spatial position of the holding pins on the dental restoration in the blank. In this way for example the technical advantage is achieved that the spatial position of the holding pins is determined quickly and efficiently.

In a further technically advantageous embodiment of the method, the machine learning algorithm sets the angle of the holding pins on the dental restoration and the blank. In this way for example the technical advantage is achieved that the angle of the holding pins is determined quickly and efficiently.

In a further technically advantageous embodiment of the method, the machine learning algorithm sets the number, shape and/or size of the holding pins on the dental restoration and the blank. In this way for example the technical advantage is achieved that the number, shape and/or size of the holding pins is determined quickly and efficiently.

In a further technically advantageous embodiment of the method, the machine learning algorithm integrates spatial data for a sinter block into the three-dimensional dataset. The machine learning algorithm can hereby automatically determine whether the sinter block is required for the dataset to be processed or which geometry the sinter block should have. The dataset comprises in this case data for the blank, the restoration, holding pins and sinter block. The sinter block is used for the subsequent sintering of the dental restoration in a sintering furnace as a support for the remaining restoration, for example in restorations of zirconium or cobalt chromium. The sinter block can be formed to be crescent-shaped, rectangular or be formed by transverse braces. In this way for example the technical advantage is achieved that in addition to the holding pins a sinter block of the dental restoration is generated. When generating the data for the sinter block, the position, angle, number, shape and/or size of the holding pins can be taken into consideration.

In a further technically advantageous embodiment of the method, the machine learning algorithm integrates data for predetermined cutting points or predetermined breaking points of the holding pins into the three-dimensional dataset. The machine learning algorithm can hereby automatically determine where and when predetermined breaking points are placed. For example, the machine learning algorithm can provide no predetermined breaking points on those holding pins which are connected to the sinter block. In this way for example the technical advantage is achieved that the holding pins can be separated easily.

In a further technically advantageous embodiment of the method, a blank is processed by a milling device according to the three-dimensional dataset. In this way for example the technical advantage is achieved that the blank can be automatically produced.

According to a second aspect, this technical object is achieved by a computer program, comprising instructions which, when the computer program is executed by a computer, cause said computer to carry out the method according to the first aspect. In this way, the same technical advantages are achieved as by the method according to the first aspect.

According to a third aspect, this technical object is achieved by a milling machine and/or grinding machine having a computer program according to the second aspect. In this way, the same technical advantages are achieved as by the method according to the first aspect.

In an embodiment, a non-transitory computer readable medium has stored thereon instructions for automated processing of spatial data for holding pins for fixing the dental restoration into a three-dimensional dataset for a blank.

A computing apparatus having a memory coupled to a processor is configured to be capable of executing programmed instructions stored in the memory to carry out the method steps discussed herein.

### BRIEF DESCRIPTION OF THE DRAWINGS

Exemplified embodiments of the invention are illustrated in the drawings and are described in more detail hereinunder.

In the drawings:

FIG. 1 shows a diagram of a three-dimensional dataset for describing the spatial shape of the dental restoration;

FIG. 2 shows a further diagram of a three-dimensional dataset for describing the spatial shape of the dental restoration;

FIG. 3 shows a further diagram of a three-dimensional dataset for describing the spatial shape of the dental restoration;

FIG. 4 shows a further diagram of a three-dimensional dataset for describing the spatial shape of the dental restoration having a sinter block;

FIG. 5 shows a block diagram of a method for producing a dental restoration;

FIG. 6 shows a view of a milling machine for implementing the method by means of a blank; and

FIG. 7 shows a view of a blank.

### DETAILED DESCRIPTION

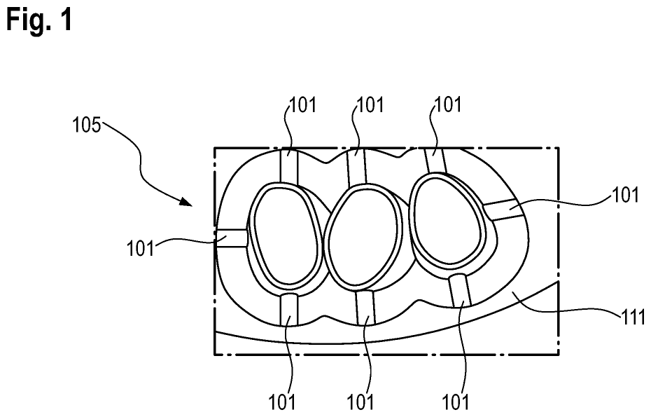

FIG. 1 shows a diagram of a three-dimensional dataset 105 for describing the spatial shape of the dental restoration 100. A dataset of the restoration is derived from a dataset which reproduces the patient situation and is obtained by a scan model, an intra-oral scan or a desktop scan. The dental restoration 100 is a shaped prosthesis part, by means of which tooth defects or destroyed tooth substance are replaced. The shape of the dental restoration 100 in a blank 111 is described by the three-dimensional dataset 105. The dataset 105 comprises data which describe the shape of the dental restoration.

The dental restoration 100 can be milled out of the disc-shaped blank 111 on the basis of the three-dimensional dataset 105. The dental restoration 100 is milled out of the blank 111 such that it is still held in the blank 111 by holding pins 101. After the milling process, the dental restoration 100 is still connected to the remaining blank 111 via the holding pins 101.

The illustrated dental restoration 100 is held by eight distributed holding pins 101 arranged in various ways. The holding pins 101 can each be provided on the dental restoration 100 at different positions, at different angles and with different shapes. The number of holding pins 101 can also be selected differently.

A machine learning algorithm is used for automatically integrating spatial data for the holding pins 101 into the three-dimensional dataset of the blank. The machine learning algorithm is an algorithm which learns from previous examples in the form of three-dimensional datasets and can generalise them after the end of the learning phase such that holding pins are automatically calculated. For this purpose, it can build up a statistical model based on training data during machine learning. Patterns and principles in the training data are recognised for positioning holding pins 101. The machine learning algorithm can comprise for example a trained neural network.

After the end of the original learning phase, the learning phase can be continued using adapted case examples which permit adaptation of the positioning of the holding pins in terms of shape, angle, size, number. As a result, an improvement in the machine learning algorithm is achieved. The continuation of the learning phase is preferably performed automatically or after a predetermined number of cases with a deep learning database. This can relate to all parameters, such as for example predetermined breaking points and sinter block.

The deep learning database can store a multiplicity of three-dimensional datasets 105 of individual case examples, in which the holding pins have been optimised. The database can be stored locally or in a network-based or cloud-based manner. In the cloud-based database, case examples of different users can be stored so that an extensive collection of case examples in the form of three-dimensional datasets 105 is produced. The machine learning algorithm can be further trained by retrieving three-dimensional datasets 105 with the integrated spatial data for holding pins 101.

Data for holding pins 101 can be automatically integrated into the three-dimensional dataset of the blank 111 by the trained machine learning algorithm. This three-dimensional dataset 105 can then be used to process the dental restoration 100. The machine learning algorithm can be trained for example from previous training data so that this sets the position, number, shape, size and/or angle of the holding pins 101 on the dental restoration 100 and the blank 111.

The training data for training the machine learning algorithm can originate from an individual user or a group of users. If the training data from only an individual user is used, the machine learning algorithm optimally learns the design of holding pins 101 for this user. As a result, the machine learning algorithm can automatically design the holding pins as this would occur owing to the individual user. However, in addition, training data of an entire group of multiple users can also be used so that the database is enlarged accordingly. The machine learning algorithm can be trained continuously by further training data during implementation of the method, said further training data resulting from subsequent manual adaptation of the holding pins 101 by a user. The training data of the individual users or group of users can be stored in a database, such as for example a deep learning database.

The design of the dental restoration 100, which is designed in a three-dimensional manner by means of CAD software, is forwarded to CAM software after being configured as a three-dimensional dataset, such as for example an STL (standard triangulation/tesselation language) file. In the CAM software, a three-dimensional dataset of the blank 111 is displayed, into which the three-dimensional dataset of the configured restoration 100 is inserted. After the insertion, the holding pins 101 are added to the three-dimensional dataset of the configured restoration 100 by means of the machine learning algorithm, by which subsequent fixing of the dental restoration 100 in the blank 111 is achieved.

The CAD and CAM software can together be retrievable via a user interface in order to implement the design and production processes in a single software application.

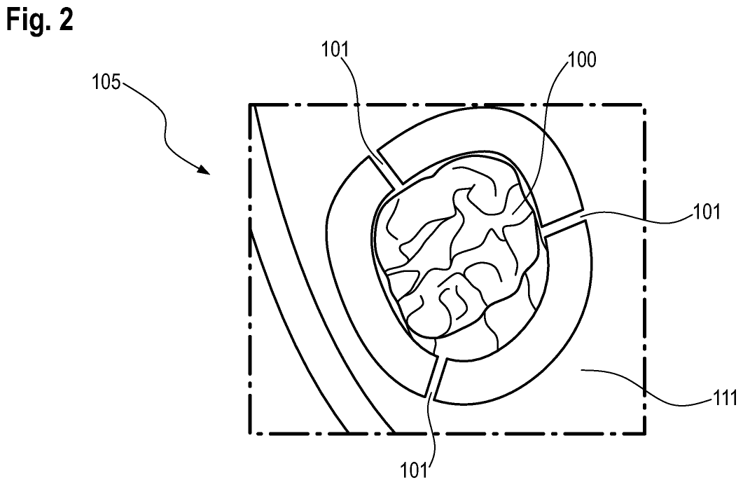

FIG. 2 shows a further diagram of a three-dimensional dataset 105 for describing the spatial shape of the dental restoration 100. In this case, three holding pins 101 are used in order to hold the subsequent dental restoration 100 in the blank 111. The three-dimensional dataset 105 comprises the spatial data of the restoration 100, the spatial data of the holding pins 101 and the spatial data of the blank 111. Integrating the spatial data for the holding pins 101 is constantly performed by the trained machine learning algorithm.

The machine learning algorithm automatically generates data for the position, number, shape, size and/or angle of the holding pins 101. The shape of the holding pins 101 can be for example conical, oval or oval-conical.

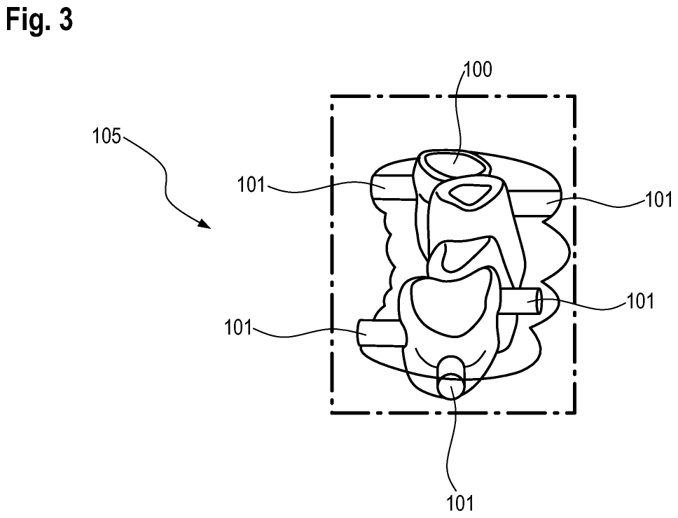

FIG. 3 shows a further diagram of a three-dimensional dataset 105 for describing the spatial shape of the dental restoration 100. In this case, five holding pins 101 are used in order to hold the subsequent dental restoration 100 in the blank 111. The three-dimensional dataset 105 likewise comprises in this case the spatial data of the restoration 100, the spatial data of the holding pins 101 and the spatial data of the blank 111. Integrating the spatial data for the holding pins 101 is constantly performed by the trained machine learning algorithm.

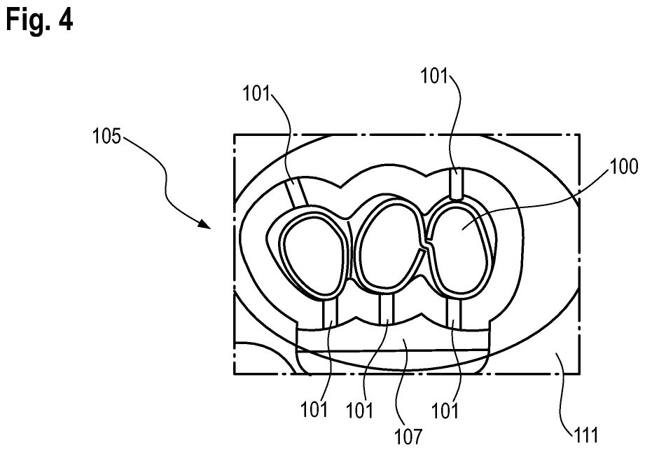

FIG. 4 shows a further diagram of a three-dimensional dataset 105 for describing the spatial shape of the dental restoration 100 having a sinter block 107. The sinter block 107 is used for the subsequent sintering of the dental restoration 100 in a sintering furnace. The spatial data for the sinter block 107 or the sinter structure is likewise integrated into the three-dimensional dataset by the trained machine learning algorithm, and so this dataset is automatically generated on the basis of empirical values.

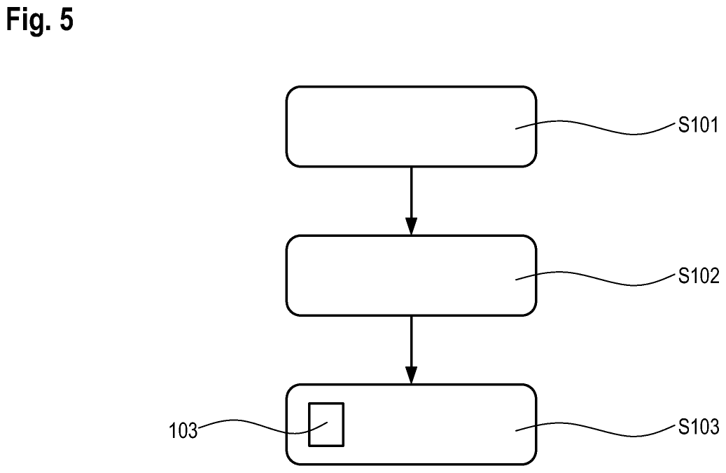

FIG. 5 shows a block diagram of a method for producing a dental restoration 100. In step S101, a three-dimensional dataset 105 is generated for describing the spatial shape of the dental restoration 100 in the blank 111. Then, in step S102 the spatial shape of the dental restoration 100 is added to a dataset of the blank 111. In step S103, spatial data for the holding pins 101 for fixing the dental restoration 100 are integrated into the three-dimensional dataset of the blank 111. The data is integrated by the machine learning algorithm 103.

In addition, the machine learning algorithm 103 can integrate data for predetermined cutting points or predetermined breaking points of the holding pins 101 into the three-dimensional dataset 105. A material weakening, such as for example a notch, can be milled into the holding pins 101 at these predetermined cutting points or predetermined breaking points, so that said holding pins can be subsequently separated easily.

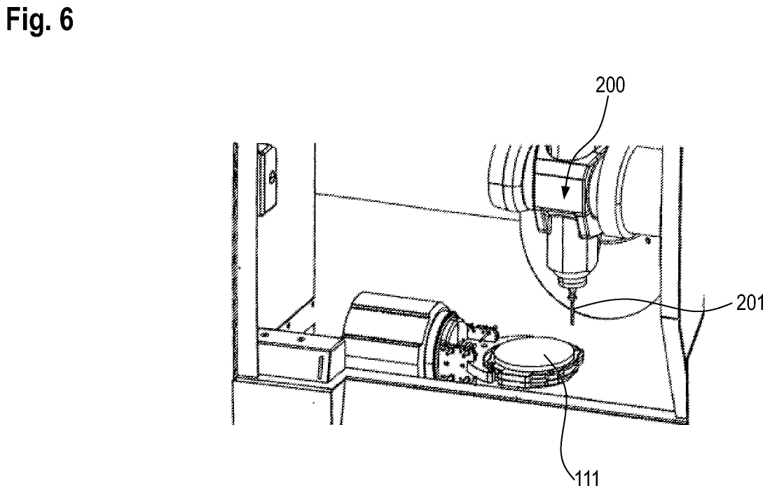

FIG. 6 shows a view of a milling machine 200 for implementing the method by means of the blank 111. The milling machine comprises a milling head 201, by means of which material can be removed from the blank 111 according to the three-dimensional dataset 105 in order to obtain the desired shape. For this purpose, CNC milling tracks are generated from the three-dimensional data in the CAM software.

The spatial dataset 105 with the data for the holding pins 101 is used to mill the dental restoration 100 from the blank 111. The dental restoration 100 is then held in the remaining blank 111 by the holding pins 101.

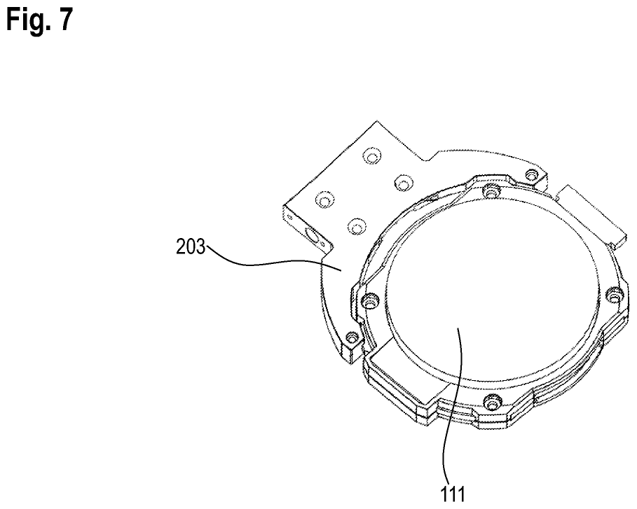

FIG. 7 shows a view of a blank 111. In this case, the blank 111 is formed by a ceramic disc, from which the dental restoration 100 is milled. This blank 111 is described by a three-dimensional dataset. The blank 111 is held in the milling device by means of a holder 203. The milling head 201 removes the material of the blank 111 in order to obtain the dental restoration 100 which is held within the blank 111 by the holding pins 101.

All features explained and illustrated in conjunction with individual embodiments of the invention can be provided in a different combination in the subject matter in accordance with the invention in order to achieve the advantageous effects thereof at the same time.

All the method steps can be implemented by devices which are suitable for carrying out the respective method step. All functions which are carried out by features relating to the device can be a method step of a method.

In some embodiments, the innovations may be implemented in diverse general-purpose or special-purpose computing systems. For example, the computing environment can be any of a variety of computing devices (e.g., desktop computer, laptop computer, server computer, tablet computer, gaming system, mobile device, programmable automation controller, etc.) that can be incorporated into a computing system comprising one or more computing devices.

In some embodiments, the computing environment includes one or more processing units and memory. The processing unit(s) execute computer-executable instructions. A processing unit can be a central processing unit (CPU), a processor in an application-specific integrated circuit (ASIC), or any other type of processor. In a multi-processing system, multiple processing units execute computer-executable instructions to increase processing power. A tangible memory may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage, one or more input devices, one or more output devices, and one or more communication connections. An interconnection mechanism such as a bus, controller, or network, interconnects the components of the computing environment. Typically, operating system software provides an operating environment for other software executing in the computing environment, and coordinates activities of the components of the computing environment.

The tangible storage may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. The output device may be a display, printer, speaker, CD-writer, or another device that provides output from the computing environment.

The scope of protection of the present invention is set by the claims and is not limited by the features explained in the description or shown in the figures.

### LIST OF REFERENCE SIGNS

100 Dental restoration

101 Holding web

103 Machine learning algorithm

105 Spatial dataset

107 Sinter block

111 Blank

200 Milling device

201 Tool

203 Holding device

1. Method for producing a dental restoration (100) from a blank comprising the steps of:
generating (S101) a three-dimensional dataset (105) for describing a spatial shape of the dental restoration (100);
adding (S102) the spatial shape of the dental restoration (100) to a three-dimensional dataset of the blank (111);
integrating (S103) spatial data for holding pins (101) for fixing the dental restoration (100) into the three-dimensional dataset (105) of the blank (111) by a machine learning algorithm (103).

2. Method as claimed in claim 1, wherein the machine learning algorithm (103) comprises a trained neural network.

3. Method as claimed in claim 1, wherein the machine learning algorithm (103) has been trained by training data of an individual user or a group of users.

4. Method as claimed in claim 3, wherein the machine learning algorithm (103) is trained during operation by further training data or individual actual case examples.

5. Method as claimed in claim 4, wherein the further training data or individual actual case examples are each stored in the form of three-dimensional datasets in a database.

6. Method as claimed in claim 1, wherein the machine learning algorithm (103) sets the spatial position of the holding pins (101) on the dental restoration (100) in the blank (111).

7. Method as claimed in claim 1, wherein the machine learning algorithm (103) sets the angle of the holding pins (101) on the dental restoration (100) and the blank (111).

8. Method as claimed in claim 1, wherein the machine learning algorithm (103) sets the number, shape and/or size of the holding pins (101) on the dental restoration (100) and the blank (111).

9. Method as claimed in claim 1, wherein the machine learning algorithm (103) integrates spatial data for a sinter block (107) into the three-dimensional dataset (105).

10. Method as claimed in claim 1, wherein the machine learning algorithm (103) integrates data for predetermined cutting points or predetermined breaking points of the holding pins (101) into the three-dimensional dataset (105).

11. Method as claimed in claim 1, wherein a blank (111) is processed by a milling device (200) according to the three-dimensional dataset (105).

12. Computer program product comprising program code, which is stored on a machine-readable medium, the machine-readable medium comprising computer instructions executable by a processor, which computer instructions cause the processor to perform the method according to claim 1.

13. Milling machine and/or grinding machine (200) comprising a processor for implementing the computer program product as claimed in claim 12.
